(19) United States
(12) Patent Application Publication
(10) Pub. No.: US 2011/0297632 A1
(43) Pub. Date: Dec. 8, 2011

(54) INSIDE WALL MOUNTED HANGING RODS

(75) Inventor: Allan Goldstein, Old Tappan, NY (US)

(73) Assignee: EMSA Sales Corporation, Old Tappen, NY (US)

(21) Appl. No.: 13/211,276

(22) Filed: Aug. 16, 2011

Related U.S. Application Data
(63) Continuation-in-part of application No. 11/734,408, filed on Apr. 12, 2007, now Pat. No. 7,997,428.

(51) Int. Cl. A47H 1/022; F16M 13/02

(52) U.S. Cl. 211/105.6; 248/222.14

(57) ABSTRACT

A universal support rod for curtains and the like has telescoping sections the ends of which are threaded for being screwed onto respective receivers mountable on facing walls in axial alignment. The receivers are fixed to the walls by fasteners which are concealed within the bore of at least one of the rod section or its mating receiver or may be mounted to the walls by tension. A decorative flange may be mounted between each receiver and its respective rod section. A support member joins two or more of the universal support rods across the wall expanse. A further J-support member is used for heavy weight bearing use of the support rod.

### RELATED APPLICATIONS

This application is a continuation-in-part of U.S. patent application Ser. No. 11/734,408 filed Apr. 12, 2007.

### FIELD OF THE INVENTION

The present invention relates to curtain rods which may be mounted to a wall or window by compression or by a securing means.

### BACKGROUND OF THE INVENTION

The present invention is directed to the mounting of rods between facing walls. Such rods are commonly used in living rooms for hanging decorative curtains and draperies, in bath rooms for hanging shower curtains, and in closets for hanging clothing. Such rods of sufficient strength may also be mounted in hallways and alcoves for use in exercise, e.g., chinning rods.

More specifically the present invention provides a universal rod in which the adjustable rod mounting can be either by tension or compression, or by secure mounting of the opposite ends of an adjustable rod between opposing walls while maintaining an aesthetically pleasing appearance.

It is known in the art to mount rods between walls for hanging various articles. Tension rods employ two telescoping sections of a rod which are urged axially apart by one or more springs. A device for securing the rod to the walls may be mounted on the ends of the rod, e.g., a rubber pad or a suction cup. Because such rods must rely wholly on friction between their ends and the adjacent walls, they are generally secure enough to support light to medium loads.

For greater strength, it is known to support each end of a rod within a seat within a central opening of a flange which is mounted on a wall by multiple screws disposed on the circumference of the flange. It is also known to mount on a wall, beams or blocks which are apertured or notched to receive the end of a rod. The appearance of such mounts with screw or nailed heads visible in an unattractive flange, beam or block can be an eyesore. Moreover, such mounting schemes generally require that the rod be of fixed length carefully cut to the right size as the ends of a telescoping adjustable rod are subject to being withdrawn from their seats, thereby causing the rod to fall to the floor. A user must decide whether to employ a tension rod or an exposed hardware mounted rod and must make this decision prior to purchase and setting up the rod at home. Further, known tension rods are limited in length and ability to traverse an opening or a wall or window area, which length is also limiting for hardware mounted rods.

A need exists for a universal telescoping rod in which the rod length can be adjusted and which the rod can either be mounted via compression and tension, or mounted with hardware. A further need exists for a rod which can be used over an extended length of a wall area, window area or shower area. A further need exists for a support connected to a telescoping rod so as to join and support multiple rods over an extended length of a wall area, window are or shower area.

### SUMMARY OF THE INVENTION

The present invention is directed to a device and methods of using the device that meet the needs discussed above in the Background Section. As described in greater detail below, the present invention, when used for its intended purposes, has many advantages over other devices known in the art, as well as novel features that result in a new device and methods for its use that are not anticipated, rendered obvious, suggested, or even implied by any prior art devices or methods, either alone or in any combination thereof.

The present invention overcomes the aforementioned shortcomings of prior art inside rod mounting arrangements by providing for choice in installation, simple installation, security, and a pleasing appearance. More particularly the present invention provides a universal support rod having two telescoping sections slidably connected with respect to one another and sharing a common longitudinal axis, each of the sections having within an end comprising a rod threaded connector with an axis, a pair of receivers having one end capable of being mounted by tension or compress receivers, each of the receivers having an axial open bore extending between a wall mountable end of the receiver and an opposite rod receiving end of the receiver and having a receiver threaded connector with an axis, the receiver threaded connector being complementary to one of the rod threaded connectors, a fastener for mounting each receiver on a respective one of two facing walls with the receiver axes in horizontal alignment, one of the rod threaded connector and the receiver threaded connector being a male connector with its threads facing away from its axis, the other of the rod threaded connector and the receiver threaded connector being a female connector having a hollow bore in which its threads face toward its axis, each fastener for mounting each receiver being at least partially disposed within the bore of its respective receiver for being hidden from view when one of the rod threaded connectors is mated with the receiver threaded connector of the receiver.

The present invention also includes a support member including a first flange having two aperatures for mounting, a mounting means for mounting said support to a ceiling wherein said mounting means is either a screw or a nail, a second flange protruding downward from the first flange, and two male threads on opposite sides of said second flange.

The present invention also includes a second support including a first flange having two aperatures for mounting, a mounting means for mounting said support to a ceiling wherein said mounting means is either a screw or a nail, and a second flange protruding downward from the first flange wherein the second flange is a J-shape.

### DESCRIPTION OF THE DRAWINGS

FIG. 1 is an exploded perspective view of a portion of a first embodiment of the invention;

FIG. 2 is an end view of a component of the first embodiment of invention shown in FIG. 1;

FIG. 3 is an environmental perspective view of the component of the first embodiment of the invention shown in FIG. 1;

FIG. 4 is an environmental perspective view of the first embodiment of the invention;

FIG. 5 is an exploded side elevation view of a portion of a second embodiment of the invention;

FIG. 6 is an assembled side elevation view of the portion of the second embodiment of the invention shown in FIG. 5;

FIG. 7 is an exploded side elevation view of a portion of a third embodiment of the invention;

FIG. 8 is an assembled side elevation view of the portion of the third embodiment of the invention shown in FIG. 7;

FIG. 9 is a side sectional elevation view in partial section illustrating a fourth embodiment of the invention;

FIG. 10 is a side sectional elevation view in partial section illustrating a fifth embodiment of the invention;

FIG. 11 is an exploded perspective view of a portion of the present invention of FIG. 1 showing the spring assembly; and

FIG. 12 is a perspective view of the support member of the present invention,

### DESCRIPTION OF THE PREFERRED EMBODIMENT

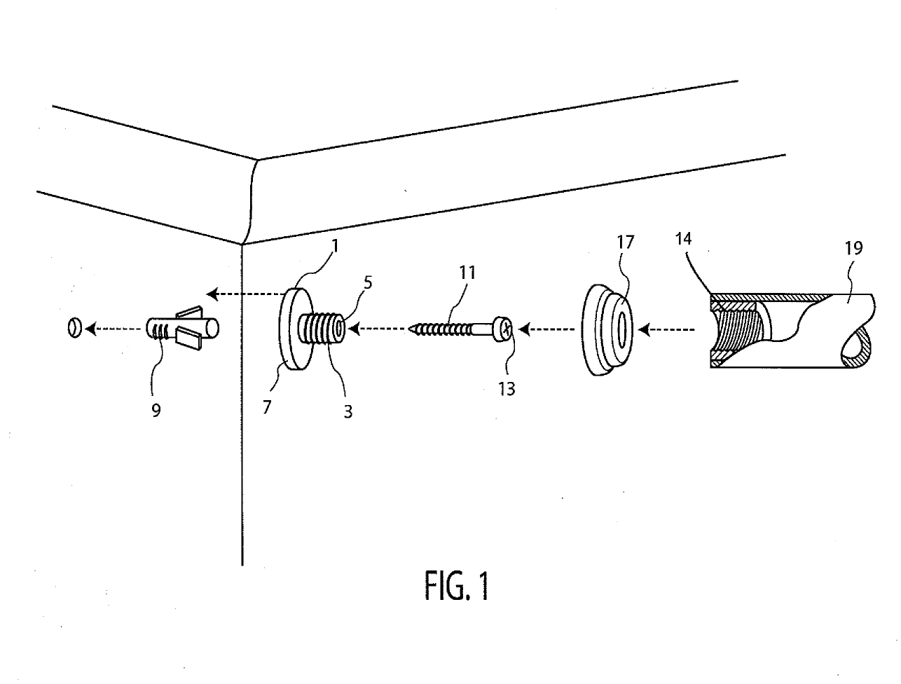

Referring now to FIG. 1 of the drawings, there is shown a rod including a receiver 1 having a threaded connector in the form of a stud 3 with male threads and a central axial open bore 5 extending between a wall mountable end of the receiver 1 and an opposite rod receiving end of the receiver 1 in communication with a central aperture 6 in a circular flange 7 from which the stud 3 extends. The circular flange 7 has one end opposite the stud 3 which is comprised of a material capable of pressure mounting the rod to a wall or window casement or other area. Such materials include but are not limited to rubber, material, felt, suction cups and the like. The rod is thus capable of tension mounting wherein the rod may be compressed, for example set within a window opening, and released. The ends of the rod forcibly bear against opposite sides of the opening and use function to retain the rod in position.

The receiver 1 may also be mounted with hardware to the wall or window casement of other area. An optional anchor 9 adapted to be driven through a hole drilled in a wall is provided for receiving the shank of a fastener which, in the preferred embodiment of the invention, is a screw 11, but which can also be a nail or other fastener having a shank and a head as will be known to those skilled in the art. The shank of the screw 11 is passed through the bore 5 and aperture with the end of the screw 11 distal from its shank penetrating the wall. Where the axis of the receiver 1 is in alignment with a stud in the wall, the anchor 9 need not be used and the screw 11 may be driven through the wall into the wall stud.

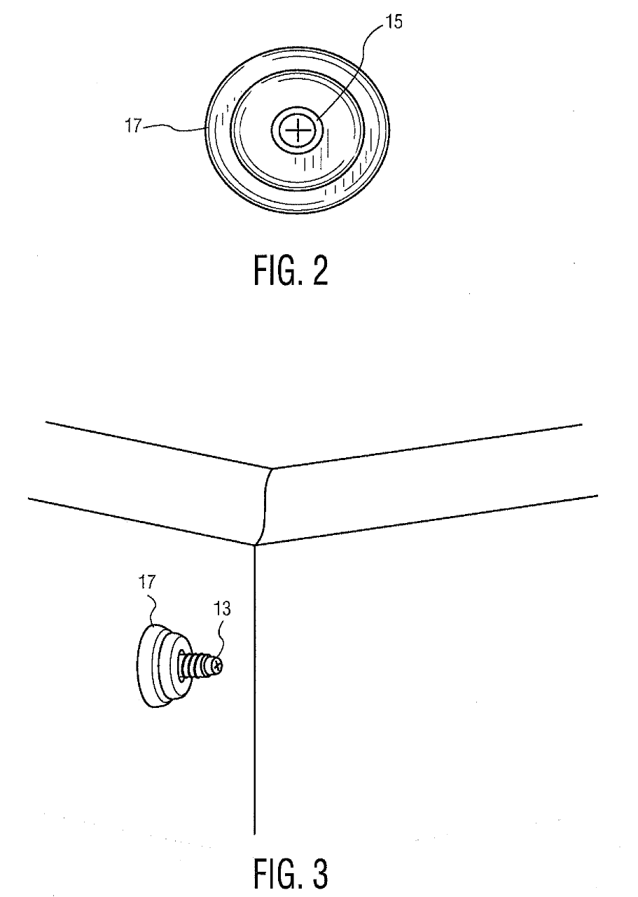

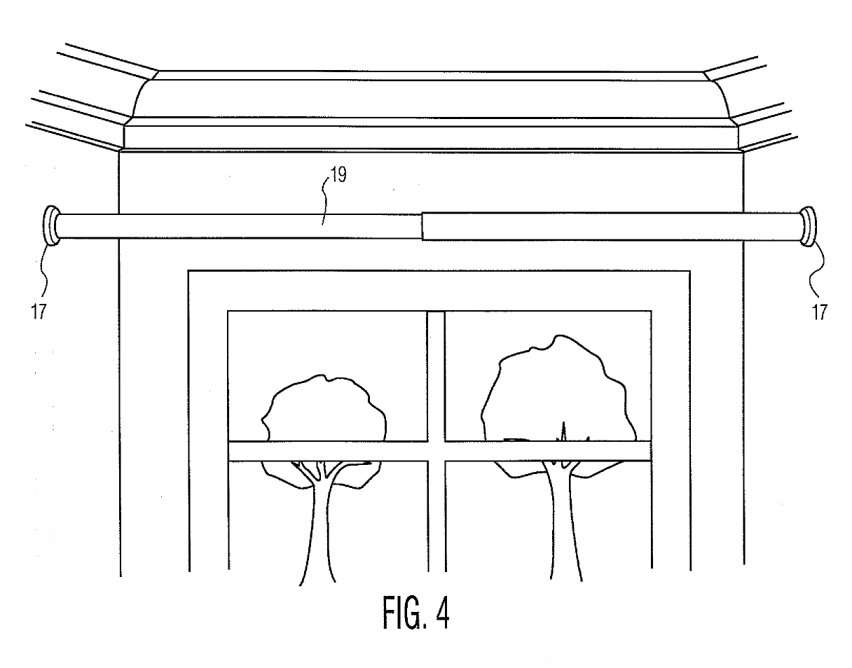

The head 13 of the screw can have a diameter smaller than the diameter of the bore 5 in which case the underside of the screw head 13 engages a circular seat in the form of a circular apertured shoulder 15 (see FIG. 2) within the bore 5 proximate the flange 7 at the wall mountable end of the receiver when the screw is fully tightened. Alternatively, as shown in FIG. 3, the head 13 of the screw 11 can have a diameter approximately equal to the outer diameter of the stud 3 and less than the diameter of the bore 5 for allowing a threaded connector in the form of a nut 14 to be passed over the head 13 and threaded onto the stud 3 when the screw 11 is fully tightened to secure the receiver 1 to the wall.

The nut 14, which has a female thread facing toward its axis, is fixedly mounted, e.g., by an interference fit, within an outer end of a section 19 of a telescoping rod or pipe having two or more sections slidably connected with respect to one another and sharing a common longitudinal axis, for enabling each section to be fastened to a receiver 1 by rotation about a mutual axis of the section 19 and receiver 1. Instead of providing a nut 14, the inner bore of the rod section may be provided with female threads facing inwardly toward the axis of the rod section, complementary to the outward facing male threads on the outer surface of the stud 3.

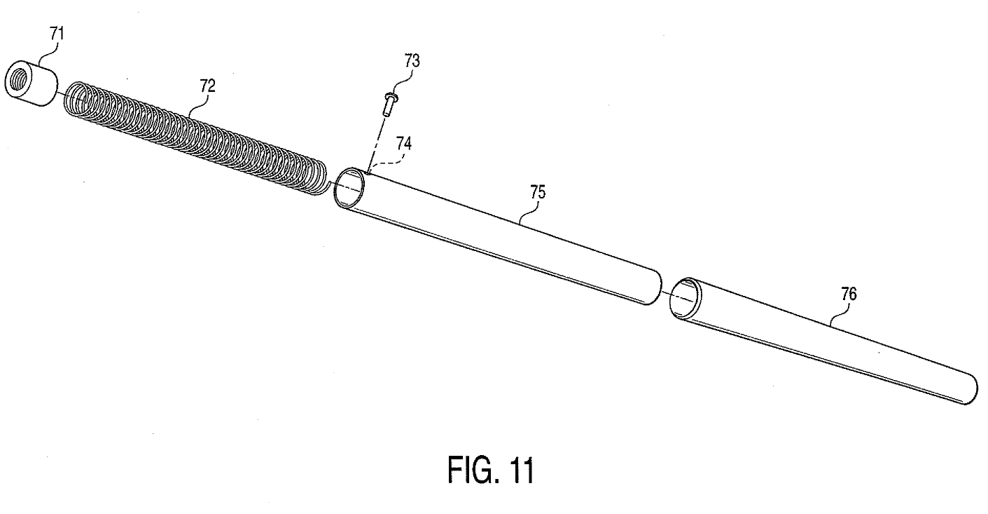

In use, two receivers 1 are on each of the telescoping rod sections. The receivers may be left as is and the rod mounted by tension or pressure as the end of the receiver 1 is comprised of a material capable of being tension mounted to a wall. In this use of the present invention, the rod generally has a spring tension rod (see FIG. 11) constructed of two telescoping rod sections 75 and 76 in a conventional manner known to those having ordinary skill in the art. A spring 72 is captured within the rod sections 75 and 76 of the rod 22. In FIG. 11 the spring 72 is held within the smaller diameter rod section 75 by a securing means 71, such as a nut, which is held within the smaller diameter rod section 75, for example, by a screw 73. Other known spring tension rod configurations are possible, including wherein the spring is set within the larger diameter rod section 76 and secured within by a securing means such as a nut or bolt, or even by the end of the narrow diameter rod section 75. The length of the telescoping rod can be changed to a desired length in a conventional manner. Any desired rod length can be selected as long as it is between the minimum and maximum length for a particular rod. Once adjusted to the selected length, the rod sections 75 and 76 can be compressed toward one another by overcoming the biasing force of the spring 72. When released, the rod returns to the selected length. Rod compression and release is performed for installation and removal. The assembled rod defines a concentric longitudinal rod axis over its length in this example.

Further, the user has the choice of removing the receiver 1 from the rod section 19 by rotating the stud 5 counter to the nut 14 and thus the receiver may be removed from the rod section 19. As described above, each of the receivers 1 may then be mounted with hardware such as screw 11 onto a respective one of two facing walls with the axes of the receivers 1 horizontal alignment, and with their threaded studs projecting toward one another. A telescoping rod prepared as described above has each of its end sections threaded onto a respective one of the studs for secure attachment to the receivers as seen in FIG, 4.

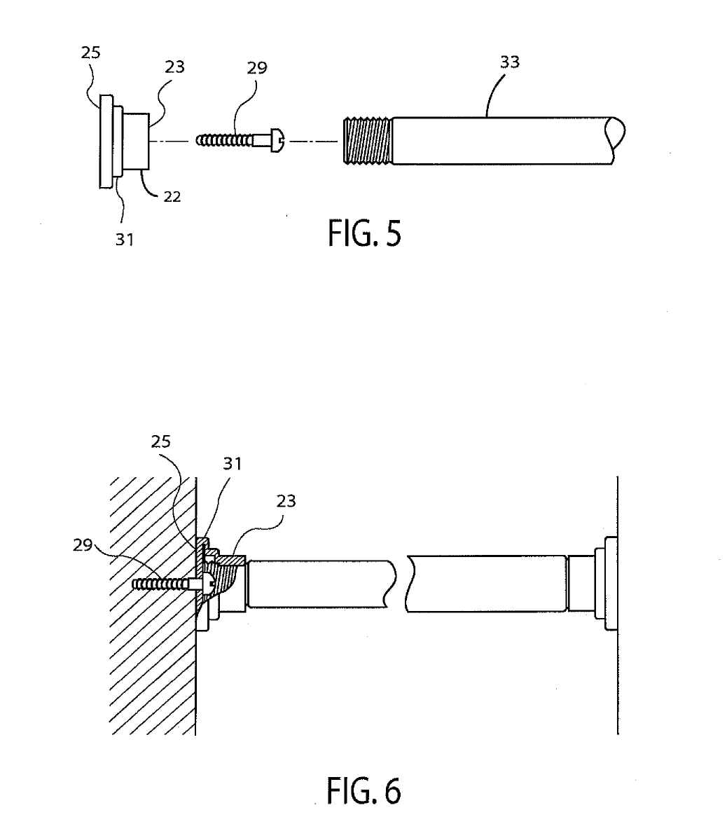

In order to enhance the appearance at the interface of the rod with the receiver, the receiver may have a stepped surface or another decorative surface such as shown in FIGS. 5 and 6. Further, a decorative collar 17 with a central aperture can be placed over the receiver 1 or the stud 3 as shown in FIGS. 1 and 3. When being mounted by hardware, as the rod section 19 is rotated onto the stud 3, the end of the section 19 engages the collar 17 thereby securing the rod section 19 and collar 17 on the receiver 1 when the rod threaded connector nut 14 and receiver threaded connector stud 3 are mated by threading the stud 3 into the nut 14. The collar 17 may be formed from a semi-resilient shape-retaining metal, plastic, or similar material thereby increasing friction with the end of the rod section 19 in the manner of a lock washer for preventing loosening of the connection between the rod section 19 and receiver 1.

Referring to FIGS. 5 and 6, in an alternative embodiment of the invention, instead of a threaded stud, a receiver 25 can be provided with a nipple 22 having a central threaded axial bore 23 in communication with a central aperture in a circular flange from which the nipple 22 extends. Again, an optional anchor adapted to be driven through a hole drilled in a wall can be provided for receiving a screw passed through the bore and aperture. The screw may be driven through the wall into a wooden stud.

The head of a screw 29 has a diameter smaller than the diameter of the bore 23 in which case the underside of the head of the screw 29 engages a circular seat at the end of the bore 23 proximate the flange 31 when the screw 29 is fully tightened.

Each outer end of an outer section of a telescoping rod or pipe 33 having two or more sections is threaded on its outer cylindrical wall for enabling the end of the section to be threaded into the bore of the receiver 25 whereby the section 33 can be fastened to the receiver 25 by rotation about a mutual axis of the section 33 and receiver 25. The outer circumference of the nipple 22 may be given a stepped configuration or other decorative or aesthetically pleasing form.

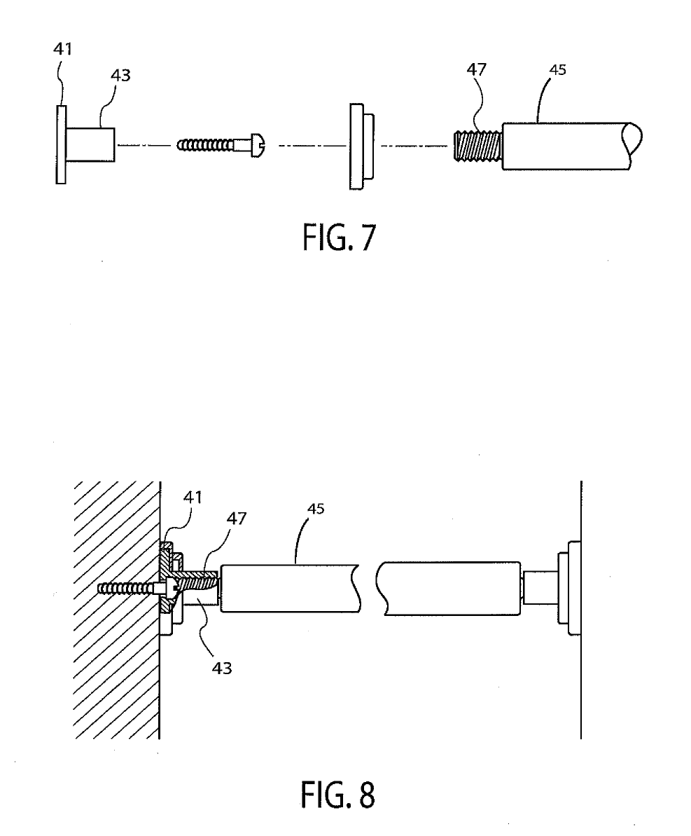

Referring now to FIGS. 7 and 8, according to still a further embodiment of the invention, a receiver 41 can be provided with a nipple 43 having a central threaded axial bore in communication with a central aperture in a circular flange from which the nipple extends and attached to a wall as explained above.

Each outer section 45 of a telescoping rod or pipe having two or more sections can be provided with a fixed threaded stud 47 extending beyond its outer end for being received within the bore in the nipple of the receiver 41. When the threaded stud 47 is fully threaded into the bore in the nipple 43, the end of the rod section 45 engages with the end of the nipple distal from the flange as shown in FIG. 8. By making the outer diameters of the rod section 45 and nipple equal 43, and squaring the end surfaces of the rod section 45 and nipple 43, the rod and nipple 43 may appear to be a unitary continuous structure.

Instead of mounting the receiver on the wall with a stud or nipple extending into the room in which the rod is to be mounted, the receiver may be mounted with the stud or nipple extending through the wall into the room.

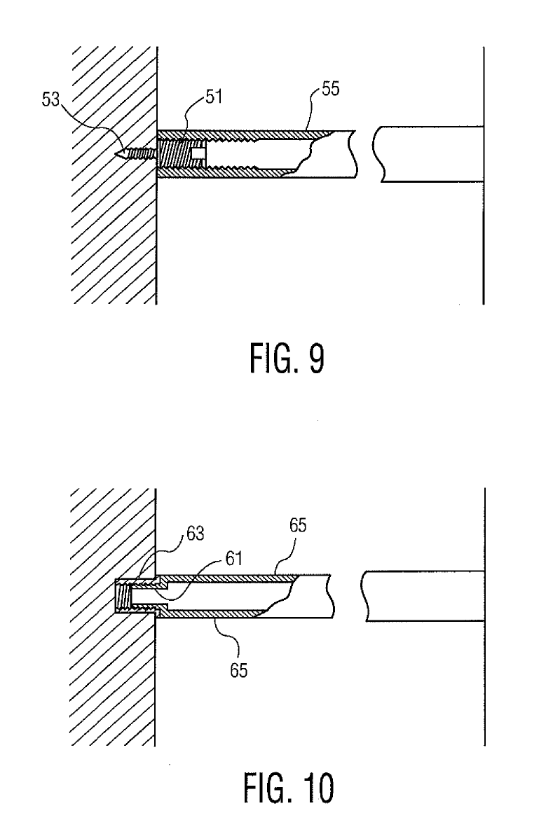

As shown in FIG. 9, a threaded stud 51 having an extending shank 53 is preferably threaded to form a screw with the stud 51 forming the head of the screw. The screw 53 is driven into the wall with the stud 51 extending into the room. A rod section 55 having a nut (not shown) fixedly mounted within its bore, or a bore which is threaded, as shown in FIG. 9, can be mounted on the stud by rotating the rod section 55 to mate the rod section 55 and receiver stud 51 until the end of the rod section 55 engages the surface of the wall, thereby rendering the receiver entirely invisible and providing a clean look with the rod extending fully between opposite walls.

FIG. 10 shows a variation of the arrangement shown in FIG. 10 wherein the cylindrical nipple of a receiver 61 can be threaded on its outer wall 63 for being received in an anchor or a hole drilled through the wall into a wall stud, and threaded on its interior for receiving threads on the end of a rod section 65, i.e., either on the outer wall of the rod section, or on a stud fixedly mounted on and extending from the end of the rod section. The nipple may extend from a flange which has a diameter less than or equal to the diameter of the rod where a stud is mounted on the rod, or only slightly greater than the diameter of the rod where the outer wall of the rod section is threaded to make the rod appear to be mounted directly on the wall.

The present invention also includes a support member 81 to combine two separate telescoping rods in use. This support member may therefore expand the length of the area or wall expanse which can be traversed by two or more telescoping rods in use. The support member 81 includes a securing means such as one ore more screws 82 for securing the support member 81 to a ceiling. The support member includes a connecting means having one or two threaded connectors in the form of a stud 83 with male threads which in use is in communication with a nut 84, which has a female thread facing toward its axis, is fixedly mounted, e.g., by an interference fit, within an outer end of a section 85 of a telescoping rod or pipe having two or more sections slidably connected with respect to one another and sharing a common longitudinal axis, for enabling each section to be fastened to a stud 83 by rotation about a mutual axis of the section 85 and stud 83. Instead of providing a nut 84, the inner bore of the rod section may be provided with female threads facing inwardly toward the axis of the rod section, complementary to the outward facing male threads on the outer surface of the stud 83.

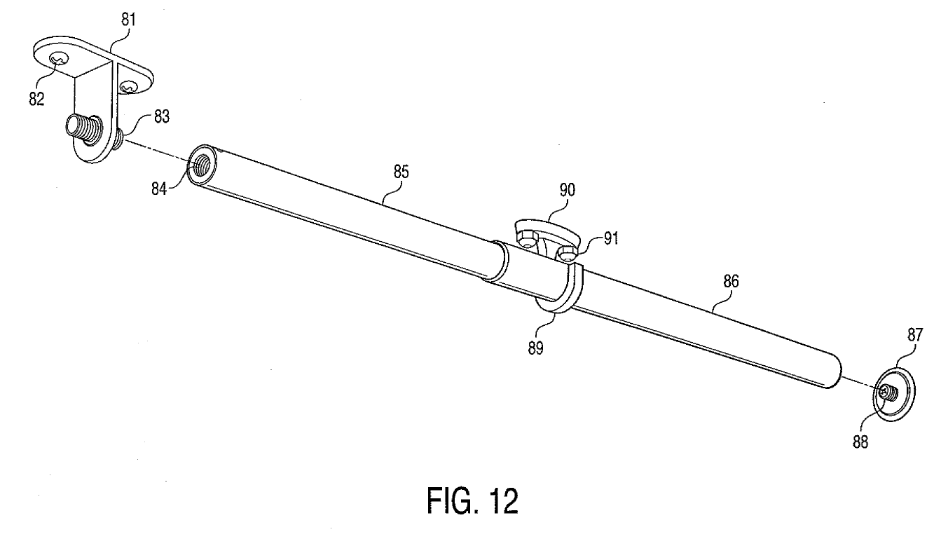

A curtain rod assembly as shown in FIG. 12 may be employed wherein one telescoping rod consisting of two rod sections 85 and 86 are connected at one end of the entire rod to the wall and the connected at the other end of the rod to the support member 81, In use, the rod is connected to the wall by connecting rod section 86 to a receiver 87 via a stud 88 with male threads, wherein the rod section 86 has female threads facing inwardly, and the rod is connected at the other end, for example rod section 85, to a support member 81 via a stud 83 with male threads connected to a female section 84 of the rod section 85. This may be repeated in a mirror connection on the other side of the support member 81 with a second telescoping rod. A combination of multiple support members and multiple telescoping rods may be employed to traverse a wall or window area. There can be any combination of rods and support members wherein one rod is connected to a wall on one side and connected to a support member on the other side, that support member is then connected to a second rod which second rod is then connected to a second wall. Further, the support member provides additional tensile support for the expanse of the wall and provides a seamless rod appearance over this expanse.

When in use the support rod may have heavy garments, curtains, drapes and the like hanging on it. To compensate for this stress on the support rod, a J-support may be mounted to the ceiling to provide additional tensile support to the support rod of the present invention. As seen in FIG. 12, J-shaped support 90 includes a securing means such as one ore more screws 91 for securing the J-shaped support 90 to a ceiling. The J-shaped support includes a J-shaped flange which curves to support the support rod and provide tensile strength to the support rod to bear additional loads. Depending on the length of the support rod, whether the support rod is mounted via the tension spring or hardware, and the load of the curtains and the like on the support rod, multiple J-shaped support may be employed. Other known shapes such as a C-shape, U-shape and L-shape may be employed, so long as they support the support rod and provide additional tensile strength when in use.

The present invention thus provides a universal support rod which can be mounted to a surface either via a tension spring and compression or can be mounted with hardware to the surface. The user therefore has a multitude of choices in how to mount the support rod. Further, the present invention provides for a decorative receiver, either alone or with a collar, which can thus hide the hardware if used. The support member allows for a seamless continuance of support rods across an expanse while also provide tensile support at the same time for the combination of two or more support rods. The J-shaped support provides tensile support for the rod when in use.

It is to be appreciated that other and further modifications and variations may be made to the embodiments herein disclosed without departing from the spirit and scope of the invention.

### PARTS LIST

1 receiver
3 stud
5 central axial open bore
6 central aperture
7 circular flange
9 anchor
11 screw
13 head of screw
14 nut
15 circular aperatured shoulder
17 collar
19 section of telescoping rod
22 nipple
23 axial bore
25 receiver
29 screw
31 flange
33 telescoping rod or pipe
41 receiver
43 nipple
45 outer section of telescoping rod
47 threaded stud
51 receiver stud
53 shank
55 rod section
61 receiver
63 outer wall
65 rod section
71 securing means
72 spring
73 screw
74 aperature
75 one section of telescoping rod
76 second section of telescoping rod
81 support member
82 screw
83 stud
84 nut
85 one section of telescoping rod
86 second section of telescoping rod
87 receiver
88 stud
90 J-shaped support
91 screw

I claim:

1. A support rod comprising:
a left receiver, a right receiver, a left tubular rod section and a right tubular rod section, all having a common axis, and a spring,
said left receiver having a wall mountable end of said left receiver capable of being mounted to a wall via tension or compression, and having an axial open bore extending between a wall mountable end of said left receiver affixed to said left fastener and an opposite rod receiving end of said left receiver, said rod receiving end of said left receiver comprising a left receiver threaded connector having threads circumscribing said common axis,
said right receiver having a wall mountable end of said left receiver capable of being mounted to a wall via tension or compression, and having an axial open bore extending between a wall mountable end of said right receiver affixed to said right fastener and an opposite rod receiving end of said right receiver, said rod receiving end of said right receiver comprising a right receiver threaded connector having threads circumscribing said common axis,
said left tubular rod section having a left threaded end with threads circumscribing said common axis and an opposite end,
said right tubular rod section having a right threaded end with threads circumscribing said common axis and an opposite end,
said opposite end of one of said left tubular rod section and said right tubular rod section being slidably mounted within said opposite end of the other of said left tubular rod section and said right tubular rod section whereby said left tubular rod section and said right tubular rod section are in telescoping relationship,
one of said left threaded end of said left tubular rod section and said left receiver threaded connector being a male connector with its threads facing away from said common axis, and the other of said left threaded end of said left tubular rod section and said left receiver threaded connector being a female connector in which its threads face toward said axis,
one of said right threaded end of said right tubular rod section and said right receiver threaded connector being a male connector with its threads facing away from said common axis, and the other of said right threaded end of said right tubular rod section and said right receiver threaded connector being a female connector in which its threads face toward said axis,
said left tubular rod section being rotatable about said common axis with respect to said left receiver for threading said left tubular rod section and said left receiver together,
a spring set within said left tubular section compressed or released based on the rotation of the left tubular section and right tubular section about said common axis, and
said right tubular rod section being rotatable about said common axis with respect to said right receiver for threading said right tubular rod section and said right receiver together,
said left tubular rod section and said right tubular rod section telescoping away from one another as said left tubular rod section is threaded onto said left receiver and said right tubular rod section is threaded onto said right receiver for securing said support rod to said left wall and said right wall, and said left tubular rod section and said right tubular rod section telescoping toward one another as said left tubular rod section is threaded off of said left receiver and said right tubular rod section is threaded off of said right receiver for releasing said support rod from said left wall and said right wall.

2. A support rod according to claim 1 wherein said left threaded end of said left tubular rod section comprises a female connector in which its threads face toward said common axis, and said left receiver threaded connector comprises a male connector with threads that face away from said common axis.

3. A support rod according to claim 1 wherein said left threaded end of said left tubular rod section comprises a nut seated in an end of said left tubular rod section.

4. A support rod according to claim 1 wherein said left threaded end of said left tubular rod section comprises a threaded length of said left tubular rod section.

5. A support rod according to claim 1 wherein said rod threaded connector comprises a male connector with its threads facing away from its axis, and said receiver threaded connector comprises a female connector having a hollow bore in which its threads face toward its axis.

6. A support rod according to claim 1 wherein said rod threaded connector comprises a threaded length of said rod section.

7. A support rod according to claim 1 wherein said rod threaded connector comprises a stud mounted on said rod section,

8. A support rod according to claim 1 wherein said rod threaded section has female threads and said receiver comprises a thread stud and a shank extending from said stud for being driven into said wall with said stud projecting therefrom for enabling said rod threaded section to be threaded onto said stud and to meet said wall.

9. A support rod according to claim 1 wherein said rod threaded section has male threads and said receiver comprises a cylinder with a threaded bore and a threaded exterior for enabling said receiver to be driven into said wall and said stud to be threaded into said receiver for enabling said rod section to meet said wall.

10. A support rod comprising:
a left receiver, a right receiver, a left collar, a right collar, a left tubular rod section and a right tubular rod section, all having a common axis, and a spring,
said left receiver having a wall mountable end of said left receiver capable of being mounted to a wall via tension or compression, and having an axial open bore extending between a wall mountable end of said left receiver affixed to said left fastener and an opposite rod receiving end of said left receiver, said rod receiving end of said left receiver comprising a left receiver threaded connector having threads circumscribing said common axis,
said right receiver having a wall mountable end of said left receiver capable of being mounted to a wall via tension or compression, and having an axial open bore extending between a wall mountable end of said right receiver affixed to said right fastener and an opposite rod receiving end of said right receiver, said rod receiving end of said right receiver comprising a right receiver threaded connector having threads circumscribing said common axis,
said left tubular rod section having a left threaded end with threads circumscribing said common axis and an opposite end,
said left collar having an aperture that receives said left receiver threaded connector, said left tubular rod section engaging a front face of said left collar and retaining said left collar on said left receiver as said left threaded end of said left tubular rod section and said left receiver threaded connector are mated and wherein said front face of the left collar contacts an end of said left tubular rod section and said left collar covers said left receiver such that when assembled the left receiver is not visible,
said right collar having an aperture that receives said right receiver threaded connector, said right tubular rod section engaging a front face of said right collar and retaining said right collar on said right receiver as said right tubular rod section and said right receiver threaded connector are mated and wherein said front face of the right collar contacts an end of said right tubular rod section and covers said right receiver such that when assembled the right receiver is not visible,
said right tubular rod section having a right threaded end with threads circumscribing said common axis and an opposite end,
said opposite end of one of said left tubular rod section and said right tubular rod section being slidably mounted within said opposite end of the other of said left tubular rod section and said right tubular rod section whereby said left tubular rod section and said right tubular rod section are in telescoping relationship,
one of said left threaded end of said left tubular rod section and said left receiver threaded connector being a male connector with its threads facing away from said common axis, and the other of said left threaded end of said left tubular rod section and said left receiver threaded connector being a female connector in which its threads face toward said axis,
one of said right threaded end of said right tubular rod section and said right receiver threaded connector being a male connector with its threads facing away from said common axis, and the other of said right threaded end of said right tubular rod section and said right receiver threaded connector being a female connector in which its threads face toward said axis,
said left tubular rod section being rotatable about said common axis with respect to said left receiver for threading said left tubular rod section and said left receiver together,
a spring set within said left tubular section compressed or released based on the rotation of the left tubular section and right tubular section about said common axis, and
said right tubular rod section being rotatable about said common axis with respect to said right receiver for threading said right tubular rod section and said right receiver together,
said left tubular rod section and said right tubular rod section telescoping away from one another as said left tubular rod section is threaded onto said left receiver and said right tubular rod section is threaded onto said right receiver for securing said support rod to said left wall and said right wall, and said left tubular rod section and said right tubular rod section telescoping toward one another as said left tubular rod section is threaded off of said left receiver and said right tubular rod section is threaded off of said right receiver for releasing said support rod from said left wall and said right wall.

11. A support rod according to claim 10 wherein said left threaded end of said left tubular rod section has an axial bore, and said left fastener comprises a shank and a head having a diameter larger than a diameter of said shank, said diameter of said shank being less than a diameter of said bore of said left receiver for enabling said shank to be received within the bore of said left receiver with one end extending therefrom into said wall, and said head has a diameter greater than the smallest diameter of the bore of the left receiver for securing said left receiver on said left fastener, said left fastener being concealed by said left tubular rod section when said left tubular rod section and said left receiver are mated together.

12. A support rod according to claim 11 wherein said left fastener comprises a screw.

13. A support rod according to claim 11 wherein said left fastener comprises a nail.

14. A support rod according to claim 11 wherein the axial open bore of said left receiver has a diameter less than the diameter of said head whereby said head can engage said rod receiving end of said left receiver when said shank penetrates said wall for maintaining said left receiver on said wall.

15. A support rod according to claim 11 further comprising a shoulder with an aperture within said bore of said left receiver for reducing the diameter of said bore, said head having a diameter less than the diameter of said bore at said rod receiving end of said left receiver and greater than a diameter of said aperture of said shoulder whereby said head can be received within a length of said bore proximate the rod receiving end of said left receiver and can engage said shoulder when said shank penetrates said wall for maintaining said left receiver on said wall.

16. A support rod according to claim 10 wherein said left threaded end of said left tubular rod section comprises a female connector in which its threads face toward said common axis, and said left receiver threaded connector comprises a male connector with threads that face away from said common axis.

17. A support rod according to claim 11 wherein said left threaded end of said left tubular rod section comprises either a nut seated in an end of said left tubular rod section or a threaded length of said left tubular rod section.

18. A support for a rod comprising:
a first flange having two aperatures for mounting,
a mounting means for mounting said support to a ceiling wherein said mounting means is either a screw or a nail,
a second flange protruding downward from the first flange, and
two male threads on opposite sides of said second flange,

19. A support rod assembly comprising:
(a) at least two support rods comprising:
a left receiver, a right receiver, a left tubular rod section and a right tubular rod section, all having a common axis, and a spring,
said left receiver having a wall mountable end of said left receiver capable of being mounted to a wall via tension or compression, and having an axial open bore extending between a wall mountable end of said left receiver affixed to said left fastener and an opposite rod receiving end of said left receiver, said rod receiving end of said left receiver comprising a left receiver threaded connector having threads circumscribing said common axis,
said right receiver having a wall mountable end of said left receiver capable of being mounted to a wall via tension or compression, and having an axial open bore extending between a wall mountable end of said right receiver affixed to said right fastener and an opposite rod receiving end of said right receiver, said rod receiving end of said right receiver comprising a right receiver threaded connector having threads circumscribing said common axis,
said left tubular rod section having a left threaded end with threads circumscribing said common axis and an opposite end,
said right tubular rod section having a right threaded end with threads circumscribing said common axis and an opposite end,
said opposite end of one of said left tubular rod section and said right tubular rod section being slidably mounted within said opposite end of the other of said left tubular rod section and said right tubular rod section whereby said left tubular rod section and said right tubular rod section are in telescoping relationship,
one of said left threaded end of said left tubular rod section and said left receiver threaded connector being a male connector with its threads facing away from said common axis, and the other of said left threaded end of said left tubular rod section and said left receiver threaded connector being a female connector in which its threads face toward said axis,
one of said right threaded end of said right tubular rod section and said right receiver threaded connector being a male connector with its threads facing away from said common axis, and the other of said right threaded end of said right tubular rod section and said right receiver threaded connector being a female connector in which its threads face toward said axis,
said left tubular rod section being rotatable about said common axis with respect to said left receiver for threading said left tubular rod section and said left receiver together,
a spring set within said left tubular section compressed or released based on the rotation of the left tubular section and right tubular section about said common axis, and
said right tubular rod section being rotatable about said common axis with respect to said right receiver for threading said right tubular rod section and said right receiver together,
said left tubular rod section and said right tubular rod section telescoping away from one another as said left tubular rod section is threaded onto said left receiver and said right tubular rod section is threaded onto said right receiver for securing said support rod to said left wall and said right wall, and said left tubular rod section and said right tubular rod section telescoping toward one another as said left tubular rod section is threaded off of said left receiver and said right tubular rod section is threaded off of said right receiver for releasing said support rod from said left wall and said right wall, and
(b) at least one support comprising:
a first flange having two aperatures for mounting,
a mounting means for mounting said support to a ceiling wherein said mounting means is either a screw or a nail,
a second flange protruding downward from the first flange, and
two male threads on opposite sides of said second flange for connecting to said female threaded portions of said left tubular rod section and said right tubular rod section.

20. The support rod assembly of claim 19 further comprising a second support including a first flange having two aperatures for mounting, a mounting means for mounting said support to a ceiling wherein said mounting means is either a screw or a nail, and a second flange protruding downward from the first flange wherein the second flange is a J-shape.
